(19) United States
(12) Patent Application Publication
(10) Pub. No.: US 2007/0250871 A1
(43) Pub. Date: Oct. 25, 2007

(54) Wireless Network Digital Electronic Device

(75) Inventors: Chih-Peng Wu, Taipei (TW); Fou-Ming Liou, Taipei (TW); Jui-Shun Pan, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTEK COMPUTER INC., Taipei (TW)

(21) Appl. No.: 11/677,118

(22) Filed: Feb. 21, 2007

(30) Foreign Application Priority Data
Mar. 27, 2006 (TW) 95110585

(51) Int. Cl. H04N 7/18; H04N 7/20; H04N 7/16

(52) U.S. Cl. 725/81; 725/62; 725/63

(57) ABSTRACT

A wireless network digital electronic device for receiving television broadcasting signals, transforming them into wireless network signals, and transmitting them to a display device is described. The wireless network digital electronic device includes a television signal receiver, a decoder, a processor, and a wireless network signal transceiver. The television signal receiver receives the television broadcasting signals, the decoder decodes the signals, and the processor encodes the decoded signals into wireless network signals. Subsequently, the wireless network signals are transmitted to the display device using the wireless network signal transceiver.

### RELATED APPLICATIONS

The present application is based on, and claims priority from, Taiwan Application Serial Number 95110585, filed Mar. 27, 2006, the disclosure of which is hereby incorporated by reference herein in its entirety.

### BACKGROUND OF THE INVENTION

1. Field of Invention

The invention relates to a wireless network digital electronic device.

2. Related Art

With the advances in electronic technology, portable electronic devices have much smaller sizes but more powerful functions. At the same time, traditional television broadcasting systems have started using digital signals. Therefore, digital television broadcasting signals have become an important standard for the next generation of televisions. They can be divided into the digital video broadcasting television (DVB-T), the advanced television system committee (ATSC), and the integrated services digital broadcasting (ISDB) systems.

Currently, European countries and Taiwan adopt the DVB-T digital television standard, while the United States adopts the ATSC system and Japan uses the ISDB system. Since the digital television broadcasting signals have the advantages of high quality and high resolution, they have been widely used by broadcasting companies and users.

Generally speaking, to watch digital television programs, a digital television box for processing the digital broadcasting signal has to be added to a traditional television or portable electronic device.

Traditional digital televisions are used at home or particular places (e.g. the digital television on a vehicle). However, portable electronic devices are featured in its portability. Therefore, it is therefore very inconvenient if one has to carry in addition a digital television box in order to watch digital television programs using a portable device.

### SUMMARY OF THE INVENTION

As described above, traditional portable electronic devices have to be connected with a digital television box in order to receive digital television broadcasting signals and displaying digital television programs. Therefore, this limits the portability of the portable electronic devices.

An objective of the invention is to provide a wireless network digital electronic device that converts the television broadcasting signals into wireless network signals, transmits them to a portable electronic device so that the portable electronic device can display digital television programs without connecting with a digital television box.

Another objective of the invention is to provide a wireless network digital electronic device that receives a control signal from a portable electronic device in order for the user to select a desired television program.

According to the above-mentioned objectives, the disclosed wireless network digital electronic device, such as a wireless network digital television box, is used to receive television broadcasting signals and convert them into wireless network signals. It is preferred to use a wireless local area network (WLAN) compliant with the Wireless Fidelity (Wi-Fi) or Worldwide Interoperability for Microwave Access (WiMAX) standard in order to transmit compressed television programs to a portable electronic device. Therefore, the portable electronic device does not need to be directly connected with a digital television box. The user can readily watch the television programs simply using its built-in wireless network function.

The disclosed wireless network digital electronic device includes a television signal receiver, a decoder, a processor, and a wireless signal transceiver. The television signal receiver receives television broadcasting signals. The decoder decodes at least some content of the television broadcasting signals. The processor receives the decoded television broadcasting signals and encodes the into wireless network signals. The wireless signal transceiver is connected with the processor for transmitting the wireless network signals to a display device.

The above-mentioned television broadcasting signal is preferably a digital television broadcasting signal, such as the DVB-T, ATSC, or ISDB signal. In a preferred embodiment of the invention, the processor compresses and encodes the television broadcasting signal into a wireless network signal compliant with the MPEG-4 multimedia standard. Preferably, the WLAN signal complies with the IEEE 802.11a, b, g, n or 802.16a standard. The display device can be, for example, a personal digital assistant (PDA) or a Sony PlayStation® Portable Handheld Entertainment System. The display device further includes a playing program, preferably decoding software, for decoding the wireless network signals and playing on the display device. The playing program has the function of switching channels. It transmits the channel selecting signal via the wireless network to the wireless network digital electronic device.

The disclosed wireless network digital electronic device further includes an internal power supply module for providing the electrical power needed by the wireless network digital electronic device. The wireless network digital electronic device preferably includes a universal serial bus (USB) connector for a connection with the corresponding USB connector of a portable electronic device, thereby charging the internal power supply module.

The disclosed wireless network digital network device enables a portable electronic device to play television programs using its built-in network function. The digital signal transmission can further prevent discontinuous signals. The signal compression, preferably in the MPEG-4 format, can further increase the quality and rate of transmitted television programs.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic view showing the preferred embodiment of the disclosed wireless network digital electronic device; and

FIG. 2 is a schematic view showing another embodiment of the disclosed wireless network digital electronic device.

### DETAILED DESCRIPTION OF THE INVENTION

The present invention will be apparent from the following detailed description, which proceeds with reference to the accompanying drawings, wherein the same references relate to the same elements.

The disclosed wireless network digital electronic device can conveniently convert television broadcasting signals into wireless network signals and transmit them to a portable electronic device. Therefore, the portable electronic device can readily display television programs without the need to directly connect to a digital television box. Through the wireless network, the portable electronic device can directly control the wireless network digital electronic device to change the program channels and contents.

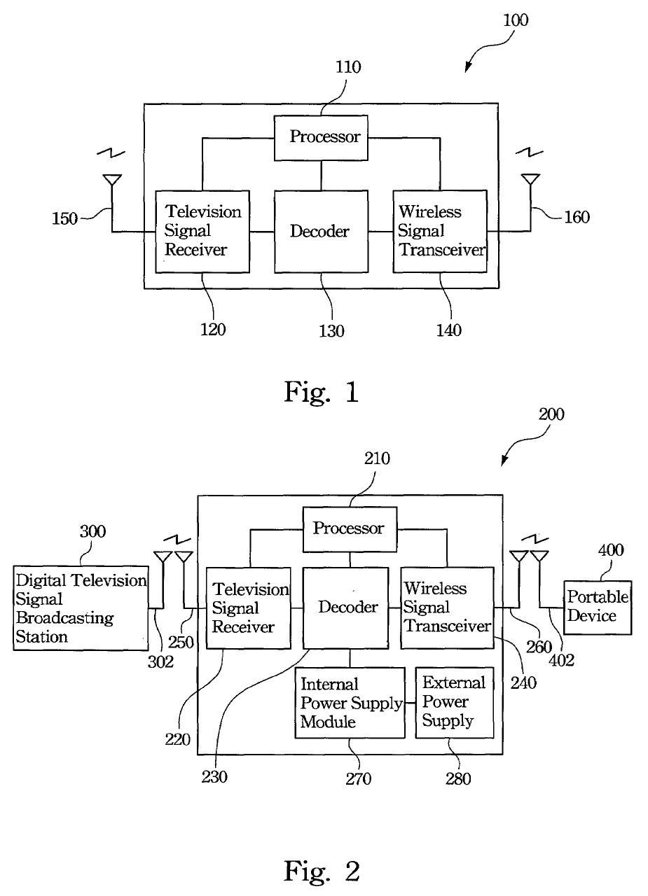

A preferred embodiment of the disclosed wireless network digital electronic device 100 is shown in FIG. 1. As shown in the drawing, the wireless network digital electronic device 100 includes a processor 110, a television signal receiver 120, a decoder 130, a wireless signal transceiver 140, an antenna 150, and an antenna 160.

The antenna 150 is used to receive digital television broadcasting signals from a broadcasting company and transmit them to the television signal receiver 120. Afterwards, the decoder 130 decodes the digital television broadcasting signals. The processor 110 compresses and encodes the television signals into wireless network signals. The wireless network signals are then transmitted to a portable electronic device using the wireless signal transceiver 140 and the antenna 160. The television programs are then played on the portable electronic device.

In particular, the digital television broadcasting signal can be a DVB-T, ATSC, or ISDB signal. Of course, the disclosed wireless network digital electronic device can also receive analog television broadcasting signals and convert them into wireless network signals for the portable electronic device to play.

In a preferred embodiment, the processor 10 compresses and encodes the television broadcasting signals into wireless network signals compliant with the MPEG-4 multimedia format. The wireless network signals are preferably Wi-Fi or WiMAX WLAN signals. For example, they are IEEE 802.11 a/b/g/n or 802.16a/e WLAN signals.

The portable electronic device can be a laptop computer, a PDA or a Sony PlayStation® Portable Handheld Entertainment System

FIG. 2 shows another embodiment of the disclosed wireless network digital electronic device. The drawing shows the structure of a digital broadcasting system. A wireless network digital television box 200 receives digital television broadcasting signals transmitted by the antenna 302 of the digital television signal broadcasting station 300, and converts them into wireless network signals. The converted signals are then transmitted to the antenna 402 of a portable device 400 for displaying.

The wireless network digital television box 200 includes a processor 210, a television signal receiver 220, a decoder 230, a wireless signal transceiver 240, an antenna 250, another antenna 260, an internal power supply module 270, and an external power supply 280. The internal power supply module 270 is preferably a chargeable battery module for providing the electrical power required by the wireless network digital television box 200. The internal power supply module 270 may also use standard batteries to supply the electrical power required by the wireless network digital television box 200 without departing from the spirits of the invention.

The wireless network digital television box 200 can also use the external power supply 280 for providing the electrical power required by the wireless network digital television box 200. The external power supply 280 is preferably connected with the internal power supply module 270 for charging it. In a preferred embodiment, the external power supply 280 includes a USB connector. Therefore, it can obtain the required external power source from the corresponding USB connector of a portable device 400 for charging the internal power supply module 270.

In a preferred embodiment of the invention, the portable device 400 uses a playing program, such as an MPEG-4 decoding program, to decode the wireless network signals and play the television program on the portable device 400. The playing program is preferably to have the function of obtaining the channel selecting signal produced by the user on the portable device 400. The antenna 402 transmits the channel selecting signal via the wireless network to the wireless network digital television box 200 in order to switch the television channel.

In this embodiment, the wireless network digital television box 200 adopts the MPEG-4 format to efficiently compress the television program signals. This enables the portable device 400 to play more smoothly. The wireless network transmission of signals to the portable device 400 further effectively prevent possible signal missing and bad quality due to the moving portable device 400. Using the wireless network, the user can readily use the portable device 400 to send a channel selecting signal to the disclosed wireless network digital television box 200 without the need for an additional infrared remote control. Within an effective range of the wireless network signals, the disclosed wireless network digital television box 200 can be controlled to switch the television channels.

In summary, the disclosed wireless network digital television box converts television broadcasting signals into wireless network signals and sends them to a portable electronic device, so that the portable electronic device can directly use its built-in wireless network function to receive television program signals without connecting to a digital television box. It further provides a channel selecting function. Such features effectively increase the usage range of the portable electronic device for the convenience of the user to watch television programs thereon.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A wireless network digital electronic device, comprising:
a television signal receiver for receiving television broadcasting signals;
a decoder connected to the television signal receiver for decoding at least some content of the received television broadcasting signals;
a processor connected to the television signal receiver and the decoder for receiving the decoded content of the received television broadcasting signals and encoding the content into wireless network signals; and
a wireless signal transceiver connected to the processor for transmitting the wireless network signals to a display device to play.

2. The wireless network digital electronic device of claim 1, wherein the television broadcasting signals are digital television broadcasting signals.

3. The wireless network digital electronic device of claim 2, wherein the digital television broadcasting signals are in the digital video broadcasting television (DVB-T) standard.

4. The wireless network digital electronic device of claim 2, wherein the digital television broadcasting signals are in the advanced television system committee (ATSC) standard.

5. The wireless network digital electronic device of claim 2, wherein the digital television broadcasting signals are in the integrated services digital broadcasting (ISDB) standard.

6. The wireless network digital electronic device of claim 1, wherein the processor compresses and encodes the television broadcasting signals into the wireless network signals in the MPEG-4 multimedia format.

7. The wireless network digital electronic device of claim 1, wherein the wireless network signals are the wireless local area network (WLAN) signals in the Wireless Fidelity (Wi-Fi) or Worldwide Interoperability for Microwave Access (WiMAX) standard.

8. The wireless network digital electronic device of claim 1, wherein the WLAN signals are IEEE 802.11a, b, g, n, 802.16a or e WLAN signals.

9. The wireless network digital electronic device of claim 1, wherein the display device is a personal digital assistant (PDA).

10. The wireless network digital electronic device of claim 1, wherein the display device is a Sony PlayStation® Portable Handheld Entertainment System.

11. The wireless network digital electronic device of claim 1, wherein the display device includes decoding software for decoding the wireless network signals and playing them thereon.

12. The wireless network digital electronic device of claim 1, wherein the wireless signal transceiver further receives a channel selecting signal from the display device.

13. The wireless network digital electronic device of claim 12, wherein the decoder decodes the content of the television broadcasting signals according to the channel selecting signal.

14. The wireless network digital electronic device of claim 1 further comprising an internal power supply module for providing the electrical power required by the wireless network digital electronic device.

15. The wireless network digital electronic device of claim 14 further comprising a universal serial bus (USB) connector connected with the internal power supply module for charging it.

16. A wireless network digital television box, comprising:
a television signal receiver for receiving television broadcasting signals;
a decoder connected to the television signal receiver for decoding at least some content of the received television broadcasting signals;
a processor connected to the television signal receiver and the decoder for receiving the decoded content of the received television broadcasting signals and encoding the content into wireless network signals which are Wi-Fi or WiMAX WLAN signals; and
a wireless signal transceiver connected to the processor for transmitting the wireless network signals to a display device to play.

17. The wireless network digital electronic device of claim 16, wherein the processor compresses and encodes the wireless network digital television broadcasting signals into the wireless network signals in the MPEG-4 format.

18. The wireless network digital electronic device of claim 16, wherein the portable electronic device is a PDA or a Sony PlayStation® Portable Handheld Entertainment System.

19. The wireless network digital electronic device of claim 16, wherein the portable electronic device further includes decoding software for decoding the wireless network signals and the decoded signals are played on its display, and the wireless signal transceiver receives a channel selecting signal from the portable electronic device.

20. The wireless network digital electronic device of claim 16 further comprising a USB connector for the connection with a power supply that provides the electrical power required by the wireless network digital electronic device.
